(19) United States
(12) Patent Application Publication
(10) Pub. No.: US 2015/0317721 A1
(43) Pub. Date: Nov. 5, 2015

(54) ENTERPRISE MOBILE APPLICATION FOR MANAGING SALES ACTIVITES

(71) Applicants: MAHESH KUMAR T J, BANGALORE (IN); VEERARAGHAVAN RAMAN, BANGALORE (IN); PADMARAJ DHAMANE, BANGALORE (IN)

(72) Inventors: MAHESH KUMAR T J, BANGALORE (IN); VEERARAGHAVAN RAMAN, BANGALORE (IN); PADMARAJ DHAMANE, BANGALORE (IN)

(21) Appl. No.: 14/265,361

(22) Filed: Apr. 30, 2014

(51) Int. Cl. G06Q 30/06; G06F 3/0482

(52) U.S. Cl. CPC G06Q 30/0641; G06F 3/0482

(57) ABSTRACT

Methods and system are disclosed that assist in executing tasks related to managing sales activities by an app on a mobile device. In one aspect, a user interface is provided via the app on the mobile device. The user interface renders information related to appointments associated with the sales activities. Upon receiving an input, a context menu is instantiated on the user interface. The context menu includes graphical elements that are associated with user interfaces for managing the sales activities. Upon receiving an input on the graphical element, a correspondence between the graphical element and the associated user interface is determined and the corresponding user interface is instantiated. The tasks related to managing the sales activities may be executed via the app on the mobile device.

### BACKGROUND

Promoting sales of products and services for an enterprise is vital for the development of the enterprise. Such promotions may include managing the sales by engaging in customer relation management activities, such as, meeting customers, executing requested tasks for the customers, receiving feedback, etc. Sales professionals may use customized software application for managing such activities. However, accessing information related to customer relation management activities while the sales professionals are on the go may be challenging.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. The embodiments, together with its advantages, may be best understood from the following detailed description taken in conjunction with the accompanying drawings.

FIG. 1 is a block diagram illustrating a mobile device including an app, according to an embodiment.

FIG. 2 is a flow diagram illustrating a process for managing sales activities by an app on a mobile device, according to an embodiment.

FIG. 3 is a block diagram illustrating a screen of a mobile device showing a user interface provided by an app, according to an embodiment.

FIG. 4 is a block diagram illustrating a screen of a mobile device showing a user interface provided by an app, according to an embodiment.

FIG. 5 is a block diagram illustrating a screen of a mobile device showing a user interface provided by an app, according to an embodiment.

FIG. 6 is a block diagram illustrating a screen of a mobile device showing a user interface provided by an app, according to an embodiment

FIG. 7 is a block diagram illustrating a screen of a mobile device showing a user interface provided by an app, according to an embodiment.

FIG. 8 is a block diagram illustrating a user interface provided by an app on a mobile device for managing sales activities, according to an embodiment.

FIG. 9 is a block diagram illustrating a screen of a mobile device showing a user interface provided by an app, according to an embodiment.

FIG. 10 is a block diagram illustrating a screen of a mobile device showing a user interface provided by an app, according to an embodiment.

FIG. 11 is a block diagram illustrating a screen of a mobile device showing user interface provided by an app, according to an embodiment.

FIG. 12 is a block diagram of a computer system, according to an embodiment.

### DETAILED DESCRIPTION

Embodiments of techniques related to an enterprise mobile application for managing sales activities are described herein. In the following description, numerous specific details are set forth to provide a thorough understanding of the embodiments. One skilled in the relevant art will recognize, however, that the embodiments can be practiced without one or more of the specific details, or with other methods, components, materials, etc. In other instances, well-known structures, materials, or operations are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

Consumption of digital information on the go has witnessed a surge due to advancements in technology. An end user may consume such information using a portable electronic device. Portable electronic devices, herein referred to as mobile devices, may include handheld computing device, enterprise digital assistant (EDA), wearable computer, personal digital assistant (PDA), tablet computer, smartphone, Internet appliance, multifunction electronic device, etc. The mobile devices may include mobile hardware (for e.g., memory, processor, motherboard, graphic cards, etc.), mobile software (for e.g., operating system, applications, etc.), an input mechanism (for e.g., touch screen interface, keypad, etc.) to enable user interaction with the mobile device, etc. The mobile devices may exchange data or information with remotely located servers using available network or Internet services. End users may consume such data on the mobile devices using mobile applications.

Mobile applications are software applications that may be installed on or integrated in an operating system of a mobile device. Mobile applications, either standalone or integrated, herein referred to as “app” or “apps.” may be developed and distributed through private or public distribution platforms that may typically be owned by mobile operating system providers or corporate enterprises. The apps may enhance the mobility experience of the end users by providing user interfaces to access and consume digital information. The apps may be configured to provide operational features, such as, generating visualizations by analyzing and processing data, providing user interfaces (UIs) for executing specific tasks and functionalities, etc. The apps may consume personal data or business data, such as, contacts, e-mails, calendar, etc., available on the mobile devices for managing and executing such tasks and functionalities.

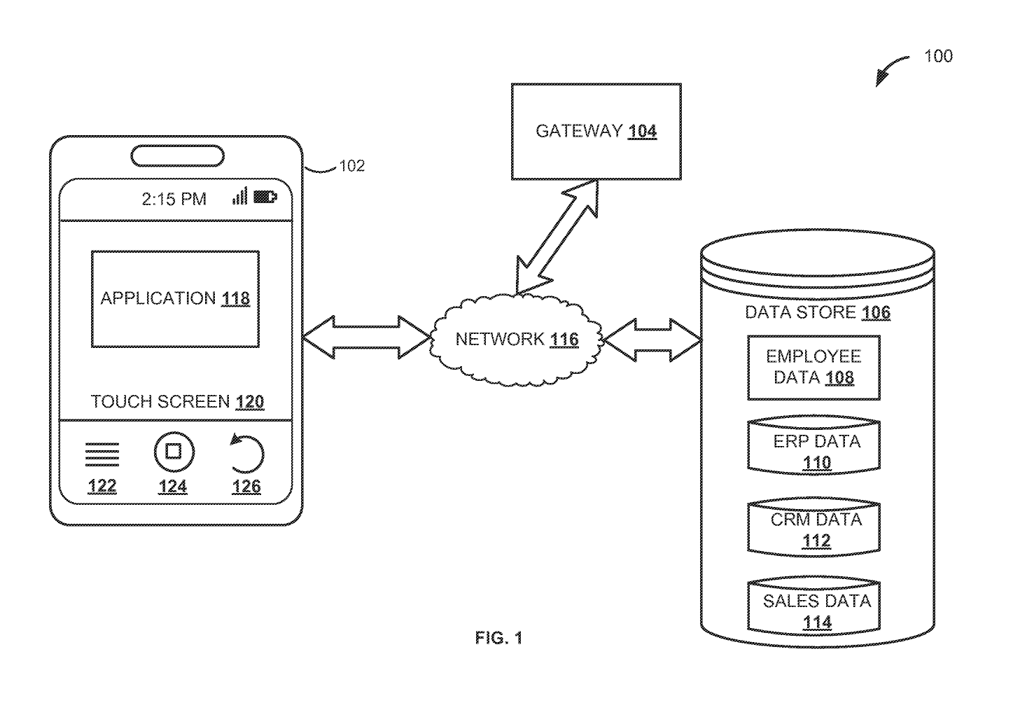

FIG. 1 is a block diagram illustrating a mobile device including an app, according to an embodiment. In an embodiment, block diagram 100 illustrates mobile device 102 communicatively coupled to gateway 104 and data store 106 over network 116. In an embodiment, gateway 104 may include protocols configured to route data between mobile device 102 and data store 106; collate data from data store 106 for consumption by end user using mobile device 102; etc. Data collation may refer to assimilating or gathering data from different data stores into a gateway, which may be modeled via a common model. The common model may structure the data assimilated from different data stores and/or systems by defining a standard model, thereby reducing the complexities associated with unstructured data.

In an embodiment, data store 106 stores personal data or business data including information related to employee data 108, enterprise resource planning (ERP) data 110, customer relation management (CRM) data 112, sales data 114, etc., associated with an enterprise. Data store 106 may include a database, an in-memory database, an operational data store, a web based data service, a database deployed in a cloud computing environment, etc., containing structured and unstructured data. The business data or personal data may be stored in multiple data structures, for example, tables, tree structures or graphs in the data store.

In an embodiment, mobile device 102 includes touch screen 120 interface to display and enable user interaction. The mobile device 102 may include buttons, such as, menu button 122, home button 124, back button 126, etc. The mobile device 102 includes application 118 related to managing an operation (for e.g. managing sales activities for an enterprise.) The application 118 may include multiple user interfaces (not shown and may be referenced as first user interface, second user interface, third user interface, fourth user interface and so on) to support execution of operations, such as, establishing a connection with gateway 104 and/or data store 106, accessing and retrieving business data onto mobile device 102, providing user interfaces for managing and executing work flow activities or tasks, etc.

In an embodiment, application 118 may include a user interface to receive parameters from a user and establish a connection with gateway 104. Upon establishing the connection, the application 118 may access and retrieve business data collated at gateway 104 onto mobile device 102. The retrieved business data may include information related to CRM data 112, ERP data 110, etc., including information related to appointments with customers. Such information may be rendered on a user interface of the app 118 on mobile device 102.

In an embodiment, a context menu (not shown) may be instantiated by clicking a button (e.g., menu button 122) on mobile device 102. The context menu includes graphical elements that may be associated with user interfaces for executing tasks related to the sales activities (e.g., managing appointments, creating a business travel plan, creating time logs for executing the appointments, etc.). Upon receiving an input on a graphical element, a correspondence between the graphical element and the associated user interface may be determined and the corresponding user interface may be instantiated. In an embodiment, instantiating the user interface may refer to providing or invoking an instance of the user interface. Determining the correspondence may include determining a relation between the graphical elements and the associated user interfaces. An end user may execute the tasks and manage sales activities via the application 118 on the mobile device 102.

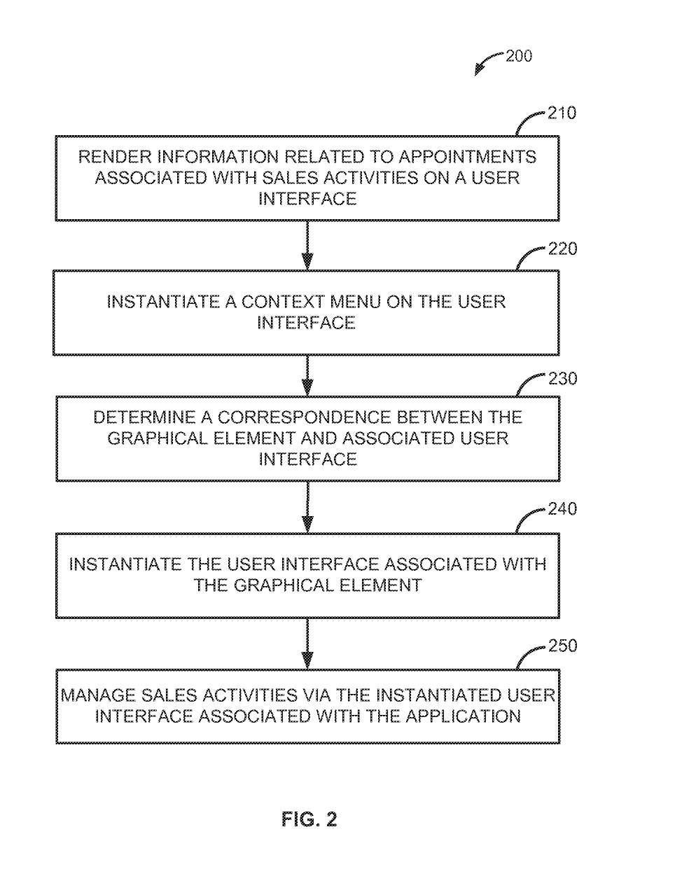

FIG. 2 is a flow diagram illustrating process 200 for managing sales activities by an app on a mobile device, according to an embodiment. Process 200, upon execution provides a mechanism for managing sales activities using an app on a mobile device. The mobile device may communicate with multiple remotely located data stores using the internet. The data stored on the data stores may include enterprise business data. Such enterprise business data may include information related to employees of the enterprise, products and services offered by the enterprise, marketing, sales and revenues information, etc. The data stores may also store structured or unstructured data generated from various systems. By way of an example, such systems may include Enterprise Resource Planning (ERP), Customer Relations Management (CRM), Business process management, Enterprise planning systems, Enterprise Feedback Management (EFM), etc.

In an embodiment, the data related to the employees may include information, such as, employee name, employee designation, employee contact information, employee payroll information, department/or business unit with which the employee is employed, calendar information, e-mails, etc. Consider “Bob Miller”, an employee working with the sales department of an organization ABC AG. Business data related to “Bob Miller” may include sales information of multiple customers that Bob handles, e.g. a service account/or customer name, a point of contact for the service account, contact information of the point of contact including a telephone number, an e-mail address, a location of point of contact, etc.

In an embodiment, Table 1, residing in a data store, exemplarily illustrates customer service accounts that “Bob Miller” is currently handling.

TABLE 1

| | | | | CONTACT |
|---|---|---|---|---|
| SERVICE | NAME OF | | | INFORMATION |
| ACCOUNT | POINT OF | | | E-MAIL |
| NAME | CONTACT | DEPARTMENT | LOCATION | TELEPHONE |
| Wal-Mart | John Smith | Sales | Munich | john.smith@wal-mart.com |
| | | | | +498997500 |
| Caterpillar | Dwayne | Marketing | Waldorf | dwayne.bravo@caterpillar.com |
| | Bravo | | | +497654990 |
| Wegmans | Steve | Product | Heidelberg | steve.gates@wegmans.com |
| | Gates | Engineering | | +497865900 |
| Mercedes | Merlin | Sales | Sinsheim | merlin.jobs@mb.com |
| Benz | Jobs | | | +496700440 |
| Target | Merissa | Support | Frankfurt | merissa.mermaid@target.com |
| | Mermaid | | | +495499999 |

The columns of Table 1 correspond to attributes of the customer service accounts including “Service Account Name,” “Name of Point of Contact,” “Department,” “Location,” and “Contact Information,” such as, e-mail address and telephone number. The rows of Table 1 correspond to attribute values of the customer service accounts. For example, the attribute values of the first row include “Wal-mart.” “John Smith,” “Sales,” “Munich,” “john.smith@wal-mart.com,” “+498997500,” and so on.

In an embodiment, consider “Bob Miller” has scheduled appointments with the above customers (listed under the column “Service Account Name”). As illustrated in Table 1, the attribute values of column “Location” include cities from Germany. “Bob Miller” travels to Germany to execute the scheduled appointments. “Bob Miller” may access the scheduled appointments on his mobile device by activating or triggering the app on his mobile device by an action, for example, a tap, a slide or a swipe. At a first instance of activation, the app provides a user interface that is configured to receive parameters to establish a connection with a gateway. For instance, the parameters may correspond to user authentication information (e.g., a user name, a password, etc.), volume of business data to be retrieved onto the mobile device, gateway information (e.g., a gateway port number, a gateway host name, etc.), etc.

In an embodiment, based on the parameters input by Bob, the app on the mobile device establishes the connection with the gateway. The gateway may be communicatively coupled with the data stores, and configured to dynamically collate data from the data stores. The gateway may further be configured to receive data from the mobile device, which is processed and saved in the data store. The gateway may authenticate the mobile device based on the parameters corresponding to the user authentication. Upon successful authentication, the mobile device may be granted access to the gateway and the app on the mobile device retrieves the data from the gateway. The parameter corresponding to the volume of data may restrict the amount of data or number of appointments associated with the sales activities to be retrieved onto the mobile device.

In an embodiment, based on the input corresponding to the parameter corresponding to the volume of data, the app retrieves information related to the appointments associated with sales activities, and renders it on a user interface at 210. For instance, the appointments may correspond to the customer service accounts of Table 1. The user interface is configured to receive an input to visually indicate a preference (e.g., a check mark with a color code, etc.) and a priority (e.g., a star mark with a color code, etc.) for executing the appointments. Based on the preference and priority, the appointments may be ordered or sorted chronologically and rendered on the user interface.

In an embodiment, “Bob Miller” may instantiate a context menu associated with the app by activating (e.g., clicking, tapping, etc.) a button on the mobile device (e.g., a menu button on the mobile device). Upon activation, the context menu associated with the app is instantiated at 220. The context menu includes graphical elements that are associated with user interfaces and may correspond to executing tasks for managing sales activities, such as, managing appointments with the customers, generating log records for executing the appointments, determining an optimal route of travel for executing the appointments, generating a travel plan for executing the appointments, creating follow up tasks and follow up appointments, generating expensing report, etc.

In an embodiment, “Bob Miller” may input his preference by an action, such as, a tap or a slide on the graphical element. Upon receiving an input, a correspondence between the graphical element and the associated user interface is determined at 230. For instance, the correspondence between the graphical element and the associated user interface may be determined based on business logic. In an embodiment, the business logic may include determining and matching identifiers of the graphical elements and the user interfaces. By way of example, the graphical element and the associated user interface may include identical identifiers. Determining a correspondence may include determining the identifier of the graphical element, determining the identifier of the user interface, and matching the determined identifiers of the graphical element and the user interface. Upon determining that the identifiers match, the user interface associated with the graphical element is instantiated at 240. The sales activities may be managed, at 250, via the instantiated user interface associated with the app.

In an embodiment, establishing a correspondence between the graphical element and the user interface may include determining attributes associated with the user interface. By way of example, to create an appointment for a new customer, “Bob Miller” may instantiate the context menu of the app and trigger or activate by selecting the graphical element corresponding to create new appointments. Upon activating the graphical element, a correspondence between the graphical element and the associated user interface may be determined. Determination of correspondence may also include determining attributes for creating the new appointment. For instance, creating new appointment may include determining attributes such as, a date and time, a location, a customer name, a point of contact, etc. Upon such a determination, the associated user interface is instantiated. The instantiated user interface may include data fields corresponding to the determined attributes. “Bob Miller” may input attribute values in the corresponding attribute data fields and save the appointment in the data store.

In an embodiment, managing the sales activities by the app on the mobile device may include managing the appointments for meeting the customers. The app on the mobile device may provide a context menu including graphical elements for managing the appointments. By way of an example, managing the appointments may include tasks such as, creating new appointments, modifying and/or editing and/or rescheduling the appointments, deleting the appointments, etc. Such tasks may be executed via the corresponding user interfaces provided by the app. The appointments may be saved on the mobile device or saved in the data store.

In an embodiment, managing the sales activities via the app on the mobile device may include generating log records for executing the appointment. The app on the mobile device may provide a context menu including graphical elements for generating log records. By way of an example, the app may provide a user interface with multiple data fields. The data fields may correspond to a start time, an end time, a project code, customer service account name, etc. The start time and the end time may respectively correspond to a beginning of execution and an end of execution of the appointments. Based on the start time and the end time, the log records for executing the appointments may be generated. The generated log records may be saved on the mobile device or stored on the data store. In another embodiment, the app may be configured to determine the attributes, such as, service account name, location, etc., corresponding to the customer service account and associated with the appointment. The values of such attributes may be retrieved and rendered on the user interface. The user interface may additionally include data fields to log start time and end time for executing the appointments. The log records so generated may be saved on the mobile device or stored in the data store.

In an embodiment, managing the sales activities by the app on the mobile device may include determining an optimal route of travel for executing the appointments. By way of an example, for the chronologically rendered appointments (as described previously), the app determines the value corresponding to the attribute “Location” (as illustrated in Table 1). Upon such determination, the coordinates of “Location” are determined and retrieved by searching map information on the mobile device. A route optimization algorithm configured with the app, may determine an optimal route of travel based on the determined coordinates. In an embodiment, the route optimization algorithm may generate optimal route of travel, based on the preference and priority of the appointments. In another embodiment, the route optimization algorithm may generate optimal routes of travel, based on the shortest travel time between the “Location” coordinates. In such a case, “Bob Miller” may re-prioritize the appointments to save travel time. In an embodiment, the optimal route of travel may be rendered on a map instantiated via the app on the mobile device.

In an embodiment, managing the sales activities by the app on the mobile device may include generating a travel plan for executing the appointments. The app on the mobile device may provide a context menu including graphical elements for creating a travel plan. By way of an example, the app may provide a user interface with multiple data fields. The data fields on the user interface may correspond to attributes related to travel, for instance, a current location, a destination, and user preferences, such as, a preferred mode of travel, a preferred time of travel, a preferred date of travel, etc. Based on the determined optimal route of travel for executing the appointments (as described previously). “Bob Miller” may input the attributes related to travel for generating the travel plan for executing the appointments. The generated travel plans may be saved on the mobile device and stored in the data stores. The travel facility provider for the enterprise may receive such travel plans and make appropriate travel arrangements.

In an embodiment, managing the sales activities by the app on the mobile may include creating follow up tasks for the appointments. By way of an example, the user interface provided for managing the appointments (as described previously), may include a data field to create follow up tasks for the appointments. For instance, “Bob Miller” may create follow up tasks and/or appointments via the app on the mobile device. Accordingly, the follow up tasks and/or appointments created via the app may be saved on the mobile device or saved in the data store.

In an embodiment, managing sales activities by the app on the mobile device may include generating an expensing report including the information related to expenditures. The app on the mobile device may provide a context menu including graphical element for generating the expensing report for executing the appointments. By way of an example, the app may provide a user interface with multiple data fields. The data fields on the user interface may correspond to attributes related to expenditures, such as, a currency, itemized expense bills related to travel, purchase of food, etc., total expenses, etc. “Bob Miller” may input the attributes related to the expenses via the app for generating expensing report. The expensing reports generated via the app may be saved on the mobile device or stored on the data store.

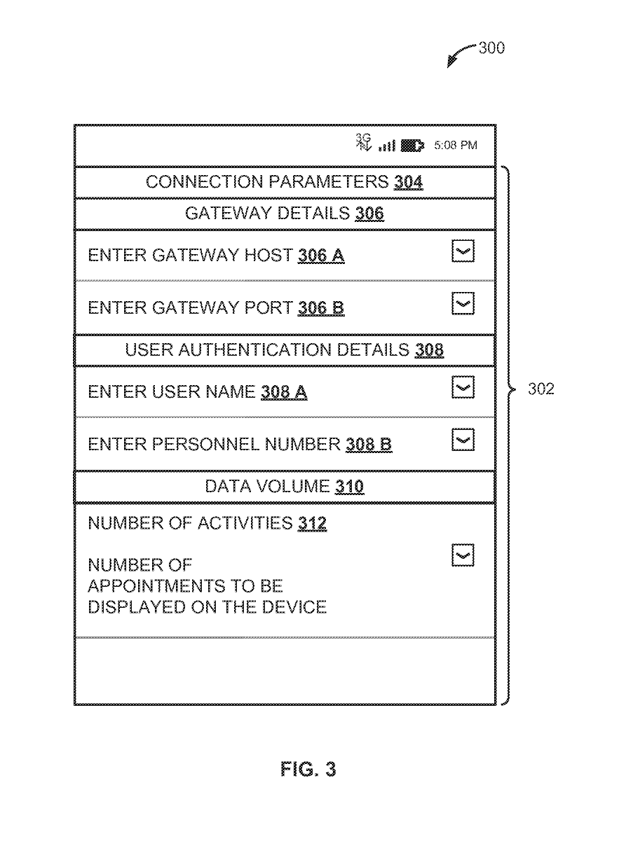

FIG. 3 is a block diagram illustrating screen 300 of a mobile device showing user interface 302 provided by an app, according to an embodiment. FIG. 3 shows user interface 302 of the app 118 on mobile device 102 for establishing a connection with gateway 104. In an embodiment, user interface 302 is configured to receive connection parameters 304 for establishing a connection with gateway 104. The connection parameters 304 include gateway details 306, user authentication details 308, and volume of data 310 to be retrieved on mobile device 102, etc. The parameters corresponding to gateway details 306 include gateway host 306 A, gateway port 306 B, etc. The parameters corresponding to user authentication details 308 include user name 308 A, password and/or a personnel number 308 B of the end user. The parameter 310 corresponding to the data 310 to be retrieved on the mobile device may include the number of CRM activities 312 to be displayed on mobile device 102. By way of an example, the number of CRM activities may correspond to number of appointments 312 to be retrieved and displayed on mobile device 102. Upon entering the corresponding parameters in their respective fields, app 118 establishes the connection with the gateway 104 and retrieves the business data collated at the gateway 104.

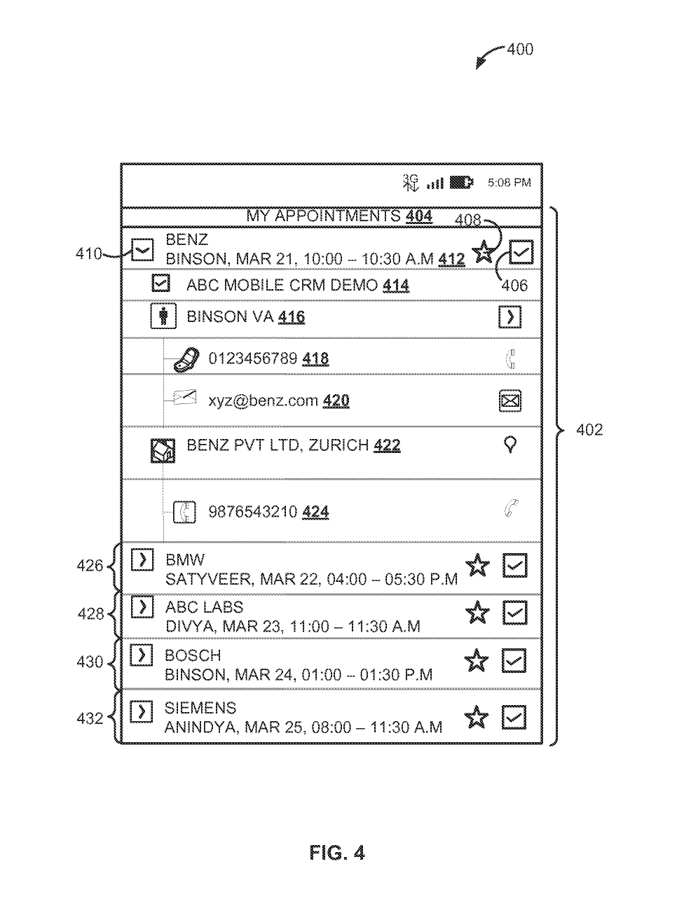

FIG. 4 is a block diagram illustrating screen 400 of a mobile device showing user interface 402 provided by an app, according to an embodiment. In an embodiment, upon establishing the connection with gateway 102, app 118 retrieves business data collated at gateway 104 onto mobile device 102. The business data may include information related to the appointments. User interface 402 is associated with app 118 renders information related to the appointments 404 of customer service accounts. The user interface 402 renders the appointments chronologically and is configured to receive an input to visually indicate preference 406 and priority 408 for executing the appointments. Based on preference 406 and priority 408, app 118 may sort the appointments chronologically and render the sorted appointments on user interface 402. In an embodiment, the details associated with the appointments may be accessed by clicking on 410. By way of example, upon clicking on 410, the details associated with the appointments, such as, a customer name 422, date and time of the appointment 412, a location 422, a short description of task for execution 414, contact details of point of contact (for e.g. name 416, email address 420, phone numbers 418 and 424, etc.), etc., may be rendered on user interface 402. The user interface 402 renders information related to appointments, such as, 426, 428, 430 and 432.

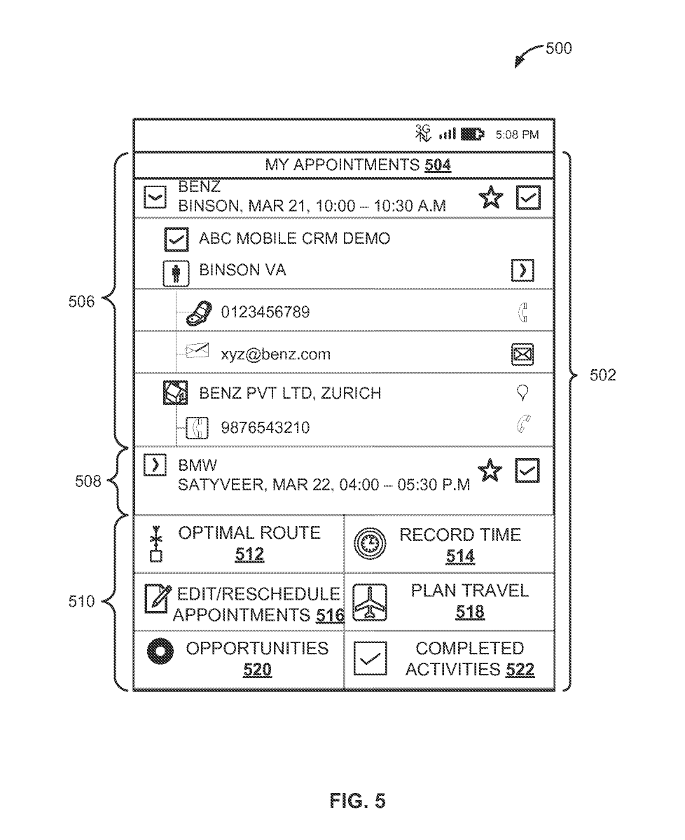

FIG. 5 is a block diagram illustrating screen 500 of a mobile device showing user interface 502 provided by an app, according to an embodiment. User interface 502 renders information related of appointments 504 and details associated with customers 506 and 508. In an embodiment, upon clicking a button (for e.g. a menu button 122) on mobile device 102, context menu 510 is instantiated and rendered on user interface 502, rendering context menu 510 including graphical elements 512-522 that may correspond to activities or tasks for managing the sales activities. FIG. 5 shows graphical elements corresponding to optimal route for travel 512, record time 514, edit/reschedule appointments 516, plan travel 518 for executing the appointments, opportunities 520, completed activities and/or appointments 522, etc.

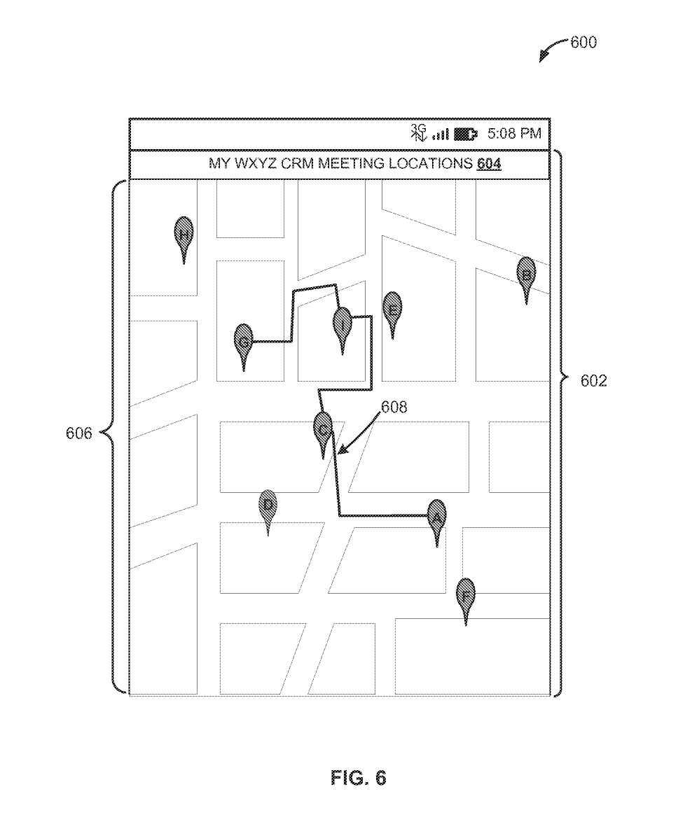

FIG. 6 is a block diagram illustrating screen 600 of a mobile device showing user interface 602 provided by an app, according to an embodiment. In an embodiment, upon receiving a selection (for e.g. via a gesture, like, a tap, a slide, etc.) on graphical element associated with rendering an optimal route of travel for executing the appointments, the associated user interface 602 is instantiated. User interface 602 renders an optimal route 608 for executing the appointments (between locations A, C, I and G). The optimal route is rendered on user interface 602 including the meeting locations 604 and map data 606 on mobile device 102. As described previously, optimal route 608 may be determined based on the preference and priority for executing the appointments.

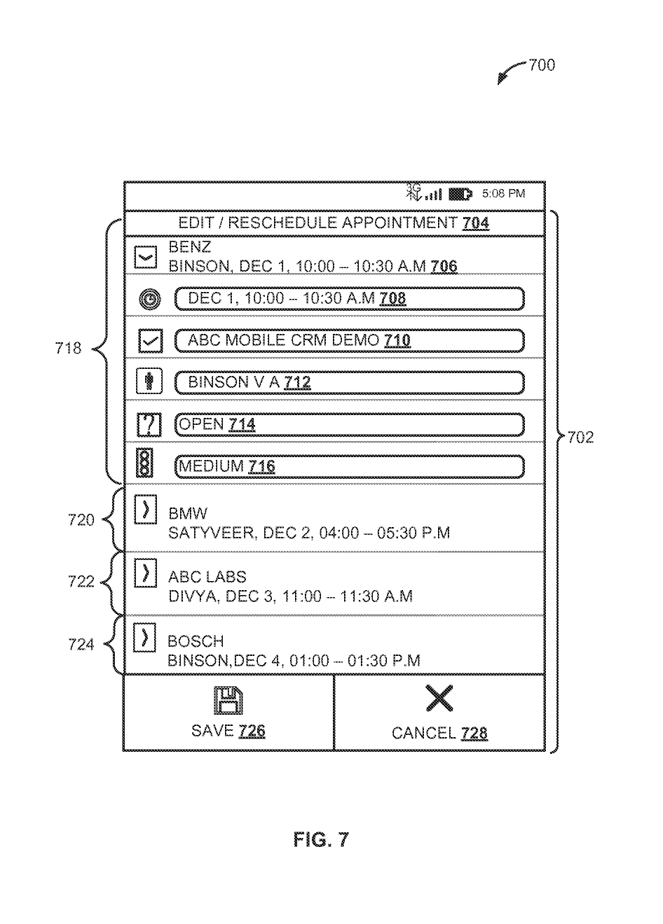

FIG. 7 is a block diagram illustrating screen 700 of a mobile device showing user interface 702 provided via by an app, according to an embodiment. In an embodiment, upon receiving an input on graphical element corresponding to edit/reschedule appointment 516, user interface 702 for editing/rescheduling the appointment is instantiated. User interface 702 includes information related to appointments 718, 720, 722, and 724. The details for appointments related to customer 706 may be edited/or rescheduled via user interface 704. FIG. 7 shows data fields, such as, date and time 708, short description of tasks of execution 710, name of contact person 712, status 714, and priority 716 for execution of the appointment. Upon editing/rescheduling, the appointment may be saved by clicking on 726 to save the data in the data store or alternately cancel editing/rescheduling the appointments by clicking on 728.

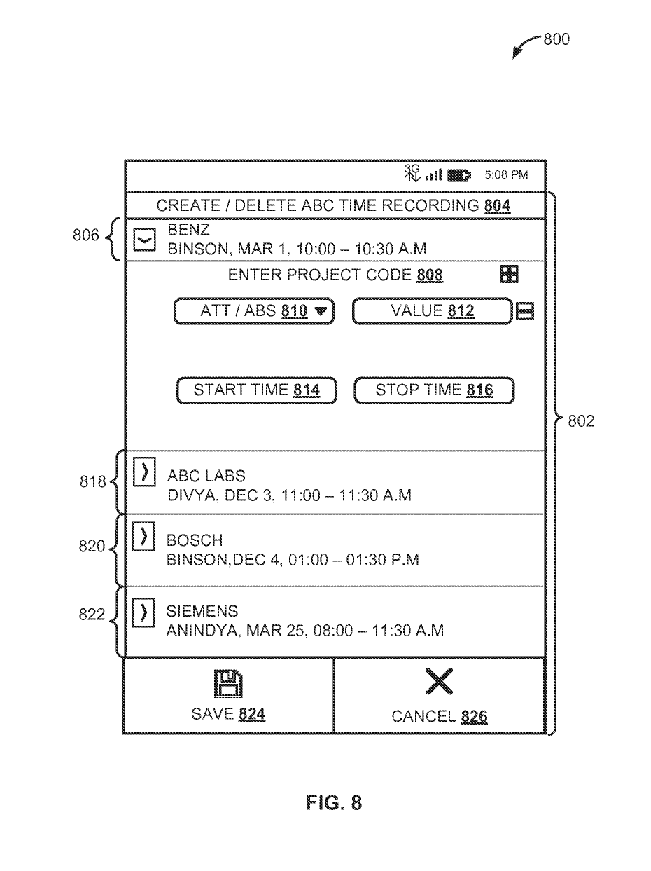

FIG. 8 is a block diagram illustrating screen 800 of a mobile device showing user interface 802 provided by an app, according to an embodiment. In an embodiment, upon receiving an input on graphical element corresponding to record time 514, user interface 802 for recording time is instantiated. FIG. 8 shows user interface 802 rendering information related to customers 806, 818, 820, and 822. The user interface 802 includes data fields 808, 810, and 812 for receiving inputs, such as, project code 808, etc., associated with customer account. The user interface 802 provides an option to modify time recordings 804 and includes data fields for logging in a start time 814 and an end time 816 for executing the appointment for customer 806. Based on the start time and the end time, the log records for executing the appointment may be created. The log records may be saved 824 in the data store or alternately cancel the task of recording time by clicking on 826.

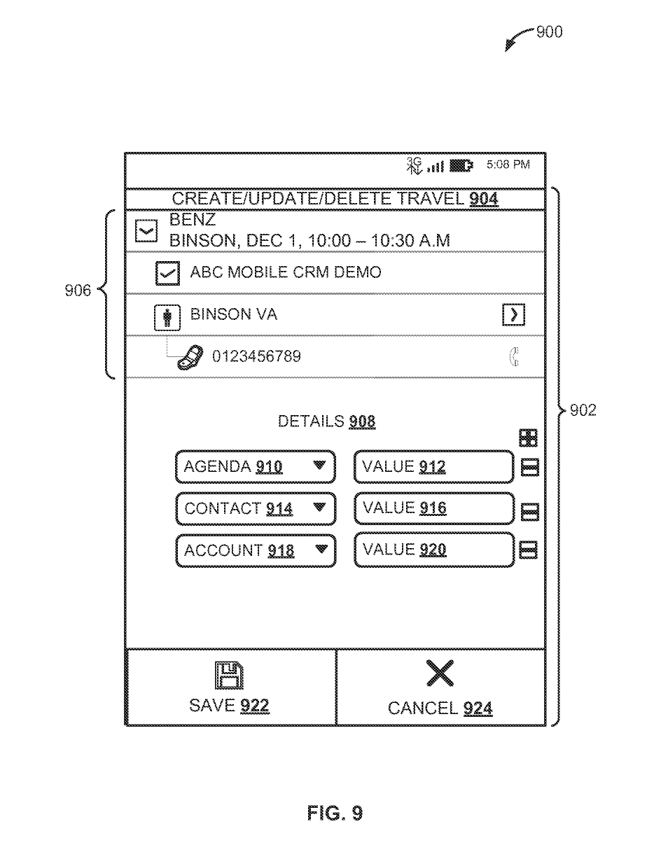

FIG. 9 is a block diagram illustrating screen 900 of a mobile device showing user interface 902 provided by an app, according to an embodiment. In an embodiment, upon receiving an input on graphical element corresponding to plan travel 518, user interface 902 for generating a travel plan is instantiated. As exemplarily illustrated, FIG. 9 shows a user interface 902 to create and/or update and/or delete travel 904 plans. The user interface 902 renders information related to customer 906 and attributes 910, 912, 914, 916, 918 and 920 related to planning the travel for executing the appointments. The attributes represented by details 908 include agenda 910, corresponding value 912; contact 914 and corresponding value 916; a cost center or account 918 and corresponding value 920, etc. Upon receiving inputs in the corresponding data fields, a travel plan for executing the appointments may be generated via the app. The generated travel plan may be saved in data store by clicking on 922 or alternately canceled by clicking on 924.

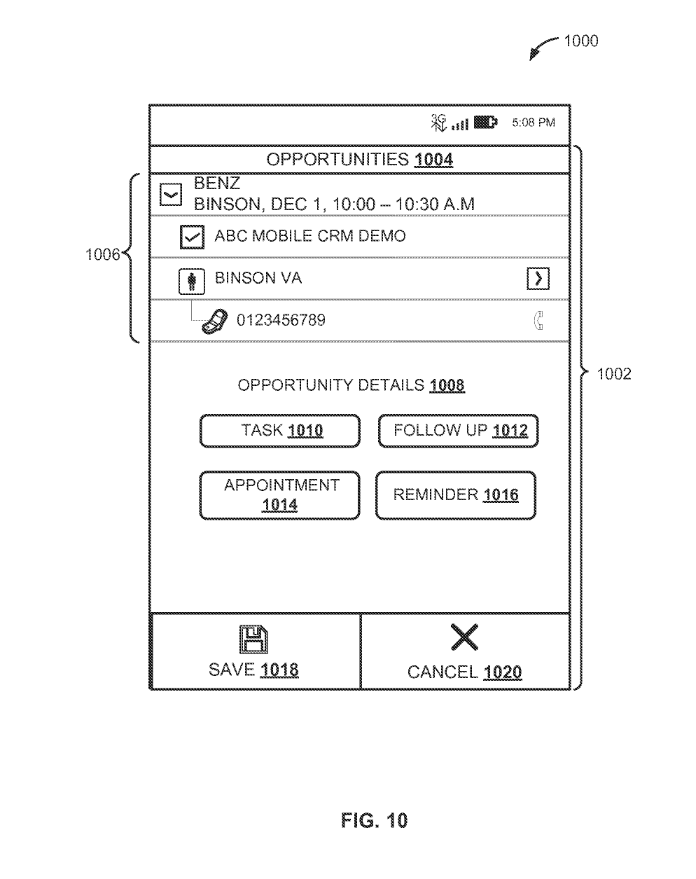

FIG. 10 is a block diagram illustrating screen 1000 of a mobile device showing user interface 1002 provided by an app, according to an embodiment. In an embodiment, upon receiving an input on the graphical element corresponding to opportunities 502, user interface 1002 for creating follow up tasks or opportunities 1004 is instantiated. As exemplarily illustrated, FIG. 10 shows user interface 1002 including opportunity details 1008 with data attributes 1010, 1012, 1014 and 1016 for creating follow up tasks/opportunities for customer 1006. The attribute task 1010 may include a short description of task; attribute follow up 1012 may include an associated flag and priority; attribute appointment 1014 may correspond to user interface for creating appointment; attribute reminder 1016 may include a reminder. The follow up tasks/opportunities and appointments may be saved to the data stores by clicking on save 1018 or alternately canceled by clicking on 1020.

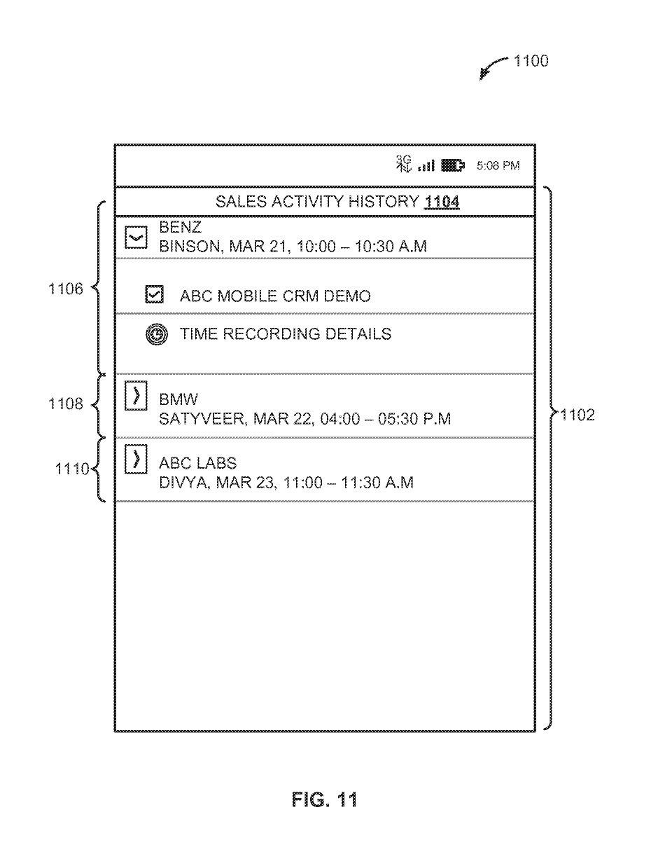

FIG. 11 is a block diagram illustrating screen 1100 of a mobile device showing user interface 1102 provided by an app, according to an embodiment. In an embodiment, upon receiving an input on the graphical element corresponding to completed activities 522, user interface 1102 rendering sales activity history 1104 is instantiated. As exemplarily illustrated, FIG. 11 shows user interface 1102 including information related to completed tasks and/or appointments for customers 1106, 1108, and 1110. The user interface may render the details (as shown by 1106) such as, a location, the time and date, the description of task, etc.

In an embodiment, the data collated at the gateway from the data stores may be modeled via a common model. By way of an example, the common model may enable structuring the data by establishing a relationship between data collated at the gateway from different systems (for e.g. ERP, CRM, business objects, cloud computing environment, web-based data services, etc.) or different data stores. The common model may be designed by determining the data models associated with the different systems. By designing and implementing such a common model, the complex operations for processing data on the mobile device may be minimized. All such operations related to data processing may be executed at the gateway, thereby enhancing the power consumption of the mobile device and improving the mobility experience.

In another embodiment, the app on the mobile device may be configured to manage activities related to services provided by an enterprise. For instance, the app may provide context menus and associated user interfaces for managing activities related to support and service of products of the enterprise. By way of an example, the app may be configured to manage tasks or activities for executing service calls, service requests, service bookings, etc., herein referred to as service requests. A service professional executing the service request may manage activities, such as, prioritizing service requests, scheduling appointments for executing service requests, creating requests for replacement parts and/or products, creating follow up tasks for managing the service requests, etc., by the app on the mobile device.

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. A computer readable storage medium may be a tangible computer readable storage medium. A computer readable storage medium may be a non-transitory computer readable storage medium. Examples of a non-transitory computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

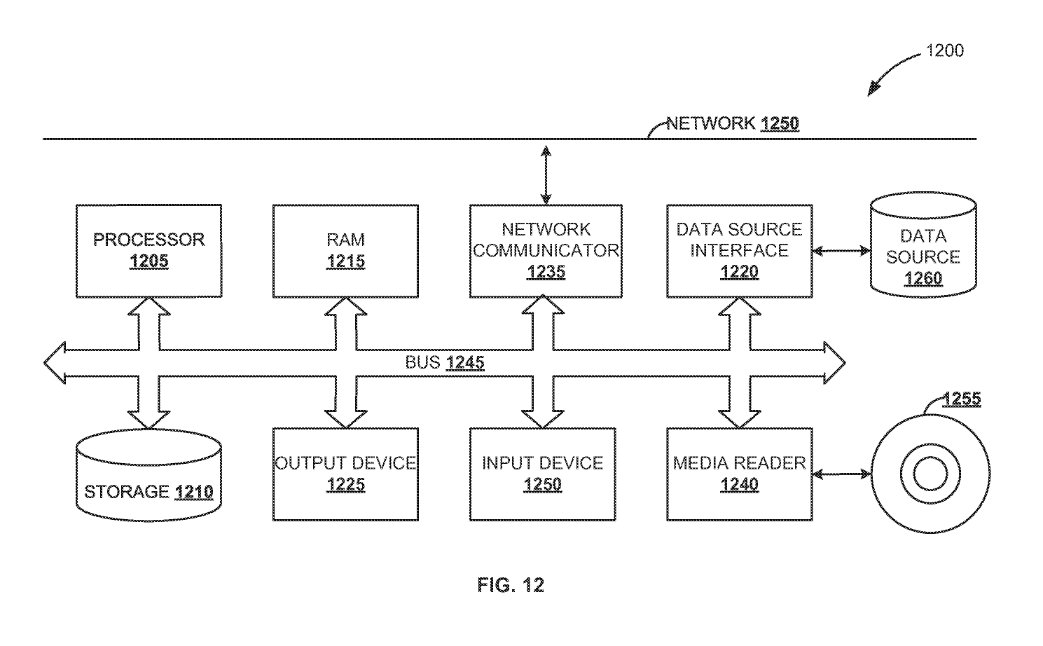

FIG. 12 is a block diagram of an exemplary computer system 1200, according to an embodiment. Computer system 1200 includes processor 1205 that executes software instructions or code stored on computer readable storage medium 1255 to perform the above-illustrated methods. Processor 1205 can include a plurality of cores. Computer system 1200 includes media reader 1240 to read the instructions from computer readable storage medium 1255 and store the instructions in storage 1210 or in random access memory (RAM) 1215. Storage 1210 provides a large space for keeping static data where at least some instructions could be stored for later execution. According to some embodiments, such as some in-memory computing system embodiments, RAM 1215 can have sufficient storage capacity to store much of the data required for processing in RAM 1215 instead of in storage 1210. In some embodiments, all of the data required for processing may be stored in RAM 1215. The stored instructions may be further compiled to generate other representations of the instructions and dynamically stored in RAM 1215. Processor 1205 reads instructions from RAM 1215 and performs actions as instructed. According to one embodiment, computer system 1200 further includes output device 1225 (e.g., a display) to provide at least some of the results of the execution as output including, but not limited to, visual information to users and input device 1230 to provide a user or another device with means for entering data and/or otherwise interact with computer system 1200. Each of these output devices 1225 and input devices 1230 could be joined by one or more additional peripherals to further expand the capabilities of computer system 1200. Network communicator 1235 may be provided to connect computer system 1200 to network 1250 and in turn to other devices connected to network 1250 including other clients, servers, data stores, and interfaces, for instance. The modules of computer system 1200 are interconnected via bus 1245. Computer system 1200 includes a data source interface 1220 to access data source 1260. Data source 1260 can be accessed via one or more abstraction layers implemented in hardware or software. For example, data source 1260 may be accessed by network 1250. In some embodiments data source 1260 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open Data Base Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the embodiments can be practiced without one or more of the specific details or with other methods, components, techniques, etc. In other instances, well-known operations or structures are not shown or described in details.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of, and examples for, the one or more embodiments are described herein for illustrative purposes, various equivalent modifications are possible within the scope, as those skilled in the relevant art will recognize. These modifications can be made in light of the above detailed description. Rather, the scope is to be determined by the following claims, which are to be interpreted in accordance with established doctrines of claim construction.

What is claimed is:

1. A computer implemented method to manage sales activities, comprising:
providing a user interface via an application on a mobile device, the user interface rendering information related to one or more appointments associated with one or more sales activities;
on the user interface, instantiating a context menu including a plurality of graphical elements, the plurality of graphical elements corresponding to a plurality of user interfaces;
upon receiving a selection of at least one graphical element, a processor of the mobile device determining a correspondence of the at least one graphical element with at least one user interface and instantiating the determined at least one user interface via the application; and
managing at least one sales activity by the instantiated at least one user interface via the application on the mobile device.

2. The computer implemented method of claim 1, wherein determining the correspondence of the at least one graphical element with the at least one user interface includes:
determining one or more identifiers of the at least one graphical element and one or more identifiers of the at least one user interface; and
matching the one or more identifiers of the at least one graphical element with the one or more identifiers of the at least one user interface to establish the correspondence between the at least one graphical element and the at least one user interface.

3. The computer implemented method of claim 1, further comprising:
upon activating the application, providing a first user interface via the application, wherein the first user interface is configured to receive one or more parameters; and
upon receiving the one or more parameters, the application on the mobile device establishing a connection with a gateway, wherein the gateway is configured to collate business data from a plurality of data stores located remotely.

4. The computer implemented method of claim 3, wherein the one or more parameters are selected from a group consisting of a gateway host, a gateway port, a user name, a password, and volume of business data to be retrieved from the gateway.

5. The computer implemented method of claim 4, further comprising:
authorizing the application on the mobile device to access the business data collated from the gateway based on the user name and the password; and
retrieving the accessed business data on the mobile device.

6. The computer implemented method of claim 1, further comprising:
receiving an input to visually indicate a preference to execute the one or more appointments;
receiving an input to indicate priority of the one or more appointments; and
ordering the one or more appointments based on the preference and the priority.

7. The computer implemented method of claim 1, further comprising:
determining one or more optimal routes of travel for executing the one or more appointments, wherein the one or more optimal routes are rendered on a map data application in the mobile device.

8. The method of claim 1, wherein managing the sales activity are selected from a group consisting of: creating one or more new appointments, editing and rescheduling the one or more appointments, and deleting the one or more appointments.

9. The method of claim 1, wherein managing the sales activity comprises:
logging a start time via a second user interface of the app to indicate a beginning of an execution of one or more tasks associated with the one or more appointments;
logging an end time via a third user interface of the app to indicate a completion of the execution of the one or more tasks associated with the one or more appointments;
generating one or more log records based on the logged start time and the logged end time for executing the one or more tasks associated with the one or more appointments; and
saving the generated one or more log records in a data store.

10. The method of claim 1, wherein managing the sales activity comprises:
based on one or more attributes associated with the one or more appointments, creating one or more travel plans via a fourth user interface of the application on the mobile device; and
saving the created one or more travel plans in a data store.

11. The method of claim 1, wherein managing the sales activity comprises:
creating one or more follow up tasks for the one or more appointments.

12. The method of claim 1, wherein managing the sales activity comprises:
generating one or more expensing reports for executing the one or more appointments by the application on the mobile device.

13. A computer system to manage sales activities, comprising:
a processor; and
one or more memory devices communicatively coupled with the processor and the one or more memory devices storing instructions to:
provide a user interface via an application on a mobile device, the user interface rendering information related to one or more appointments associated with one or more sales activities;
on the user interface, instantiate a context menu including a plurality of graphical elements, the plurality of graphical elements corresponding to a plurality of user interfaces;
upon receiving a selection of at least one graphical element, determine a correspondence of the at least one graphical element with at least one user interface and instantiating the determined at least one user interface via the application; and
manage at least one sales activity by the instantiated at least one user interface via the application on the mobile device.

14. The computer system of claim 13, wherein determining the correspondence of the at least one graphical element with the at least one user interface includes:
determining one or more identifiers of the at least one graphical element and one or more identifiers of the at least one user interface; and
matching the one or more identifiers of the at least one graphical element with the one or more identifiers of the at least one user interface to establish the correspondence between the at least one graphical element and the at least one user interface.

15. The computer system of claim 13, further comprising:
upon activating the application, providing a first user interface via the application, wherein the at least one user interface is configured to receive one or more parameters; and
upon receiving the one or more parameters, the application on the mobile device establishing a connection with a gateway, wherein the gateway configured to collate business data from a plurality of data stores located remotely.

16. The computer system of claim 13, further comprising:
receiving an input to visually indicate a preference to execute the one or more appointments;
receiving an input to indicate priority of the one or more appointments; and
ordering the one or more appointments based on the preference and the priority.

17. The computer system of claim 13, wherein managing the one or more sales activity, further comprises:
logging a start time via a second user interface of the app to indicate a beginning of an execution of one or more tasks associated with the one or more appointments;
logging an end time via a third user interface of the app to indicate a completion of the execution of the one or more tasks associated with the one or more appointments;
generating one or more log records based on the logged start time and the logged end time for executing the one or more tasks associated with the one or more appointments; and
saving the generated one or more log records in a data store.

18. The computer system of claim 13, wherein managing the one or more sales activity comprises:
based on one or more attributes associated with the one or more appointments, creating one or more travel plans via a fourth user interface of the application on the mobile device; and
saving the created one or more travel plans in a data store.

19. A non-transitory computer readable storage medium tangibly storing instructions, which when executed by a computer, cause the computer to execute operations comprising:
provide a user interface via an application on a mobile device, the user interface rendering information related to one or more appointments associated with one or more sales activities;
on the user interface, instantiate a context menu including a plurality of graphical elements, the plurality of graphical elements corresponding to a plurality of user interfaces;
upon receiving a selection of at least one graphical element, determine a correspondence of the at least one graphical element with at least one user interface and instantiating the determined at least one user interface via the application; and
manage at least one sales activity by the instantiated at least one user interface via the application on the mobile device.

20. The non-transitory computer readable storage medium of claim 19, wherein determining the correspondence of the at least one graphical element with the at least one user interface includes:
determining one or more identifiers of the at least one graphical element and one or more identifiers of the at least one user interface; and
matching the one or more identifiers of the at least one graphical element with the one or more identifiers of the at least one user interface to establish the correspondence between the at least one graphical element and the at least one user interface.
